(19) United States
(12) Patent Application Publication
(10) Pub. No.: US 2018/0051189 A1
(43) Pub. Date: Feb. 22, 2018

(54) DOUBLE-SIDED TAPE, ELECTRONIC DEVICE COMPRISING THE SAME, AND MANUFACTURING METHOD OF DOUBLE-SIDED TAPE

(71) Applicant: 3M INNOVATIVE PROPERTIES COMPANY, St. Paul, MN (US)

(72) Inventors: Do-Kwang Cho, Gyeonggi-do (KR); You-Hoon Kim, Woodbury, MN (US); Yong-Seok Seo, Gyeonggi-do (KR)

(21) Appl. No.: 15/560,244

(22) PCT Filed: Mar. 22, 2016
(86) PCT No.: PCT/US2016/023540

§ 371 Date: Sep. 21, 2017

(30) Foreign Application Priority Data
Mar. 23, 2015 (KR) 10-2015-0040105

(51) Int. Cl. C09J 7/02; C09J 133/08; B32B 7/06; B32B 7/12; B32B 27/08; B32B 27/30

(52) U.S. Cl. CPC C09J 7/0217; B32B 2309/105; C09J 133/08; B32B 7/06; B32B 7/12; B32B 27/08; B32B 27/308; C09J 2203/326; C09J 2433/00; C09J 2467/00; B32B 2307/56; B32B 2307/58; B32B 2307/748; B32B 2405/00; B32B 2457/00; C09J 7/0285

(57) ABSTRACT

The present invention relates to a double-sided tape, an electronic device including the same, and a method of preparing the double-sided tape. According to one aspect, the present invention provides a double-sided tape that contains, in order, a first adhesive layer, one or more film carrier layers, and a second adhesive layer, and a core adhesive layer between the first adhesive layer and the second adhesive layer.

### TECHNICAL FIELD

The present invention relates to a double-sided tape, an electronic device including the same, and a method of preparing the double-sided tape.

### BACKGROUND ART

Double-sided tapes (or double-sided adhesive tapes) have been usefully employed to bond components together in the manufacturing process of electronic devices, such as televisions, computers, and mobile handsets. Here, a mobile handset is a type of electronic device through which wireless communication such as voice communication, social networking services (SNSs), the Internet and various other applications can be realized, the most representative of which include cellular phones (often referred to as smartphones) and personal digital assistants (PDAs).

Recently, with the development of high-performance and high-quality versions of such electronic devices, it is common to use tempered glass as a protective cover window that is provided in front of a display panel, which functions as a touch panel, and at the same time, electronic devices with very thin bezels are more preferred. Accordingly, it may be required to adhere the tempered glass to the body of an electronic device using a double-sided tape that is prepared with a narrow width. In this case, in order to prepare a double-sided tape with a narrow width, improvements in the processability of double-sided tape are required, and this is conventionally achieved by including a stiff film-type base material in the laminated structure of the double-sided tape.

### RELATED ART

(Patent Literature 1) US Patent Application Publication No. 2007/0172648 (Published on 2007 Jul. 26.)

### SUMMARY

### Technical Problem

However, the conventional art as described above has the following problems.

When a film-type base material is included in a double-sided tape to improve the processability of the tape, the adhesion performance of the double-sided tape may be degraded by the stiff nature of the film-type base material when an external impact is applied. In other words, when an external impact is applied to an electronic device, since the double-sided tape is too stiff to buffer the impact or absorb the movement of an object(s) to be adhered, the tempered glass and body which are bonded to each other by the double-sided tape may easily separate from each other. Such a problem may occur frequently particularly in mobile handsets which are likely to be exposed to an external impact, such as when dropped by the user.

Meanwhile, when a soft foam-type base material is included in a double-sided tape instead of a film-type base material, the shock resistance of the double-sided tape may be improved. However, a foam-type base material is expensive and uneconomical. At the same time, the use of a foam-type base material reduces the processability of the double-sided tape. As a result, the manufacturing cost of the electronic device may increase.

Exemplary embodiments of the present invention are proposed to solve the aforementioned problems and directed to providing a double-sided tape that has both improved processability and enhanced shock resistance and is economical.

### Technical Solution

In one aspect, the present invention may provide a double-sided tape that includes, in order, a first adhesive layer, one or more film carrier layers, and a second adhesive layer, and a core adhesive layer between the first adhesive layer and the second adhesive layer.

In another aspect, the present invention may provide a double-sided tape that includes a first film carrier layer; a first adhesive layer that is provided on one side of the first film carrier layer; a second film carrier layer that is provided on the other side of the first film carrier layer; a second adhesive layer that is provided next to the second film carrier layer but on the opposite side of the first film carrier layer; and a core adhesive layer that is provided between the first film carrier layer and the second film carrier layer.

In another aspect, the present invention may provide an electronic device that includes a first component, a second component, and a double-sided tape, which has a first adhesive layer on one side and a second adhesive layer on the other side and bonds the first component and the second component together, where the double-sided tape includes a core adhesive layer between the first adhesive layer and the second adhesive layer.

In another aspect, the present invention may provide a method of preparing a double-sided tape that includes forming a first part and a second part, each of which has a laminated structure including a film carrier layer and a surface adhesive layer; applying a core adhesive composition on the outer surface of the film carrier layer of the first part; curing the core adhesive composition to form a core adhesive layer; and laminating the film carrier layer of the second part on the core adhesive layer.

### Advantageous Effects

The double-sided tape according to exemplary embodiments of the present invention can maintain excellent processability with a film-type base material in the structure. At the same time, the shock resistance can be improved, thus significantly reducing the occurrence of the phenomenon in which the object to be adhered is separated from the double-sided tape when an external impact is applied. Therefore, such double-sided tape can be usefully employed to bond components together in the manufacturing process of electronic devices, such as televisions, computers and mobile handsets, and can improve the durability of the electronic devices and reduce the manufacturing costs.

### BRIEF DESCRIPTION OF THE DRAWINGS

FIG. 1 shows a laminated structure of a double-sided tape of an exemplary embodiment of the present invention.

FIG. 2 is an exploded perspective view of an example of an electronic device that includes a double-sided tape of an exemplary embodiment.

Each of FIG. 3 and FIG. 4 schematically illustrates a method of preparing a double-sided tape according to an exemplary embodiment of the present invention.

FIG. 5 schematically shows a specimen for the measurement of the shock resistance and adhesive strength of a double-sided tape of an exemplary embodiment.

FIG. 6 is a graph that shows results of drop energy and push-out strength, which were measured on the specimen of FIG. 5, of each sample.

FIG. 7 is a graph that shows a measured result of the rheology property of a double-sided tape of an exemplary embodiment.

### DETAILED DESCRIPTION

Hereinafter, exemplary embodiments will be described in detail with reference to the accompanying drawings, for the realization of the spirit of the present invention. Here, the drawings are not drawn to scale for the convenience of description.

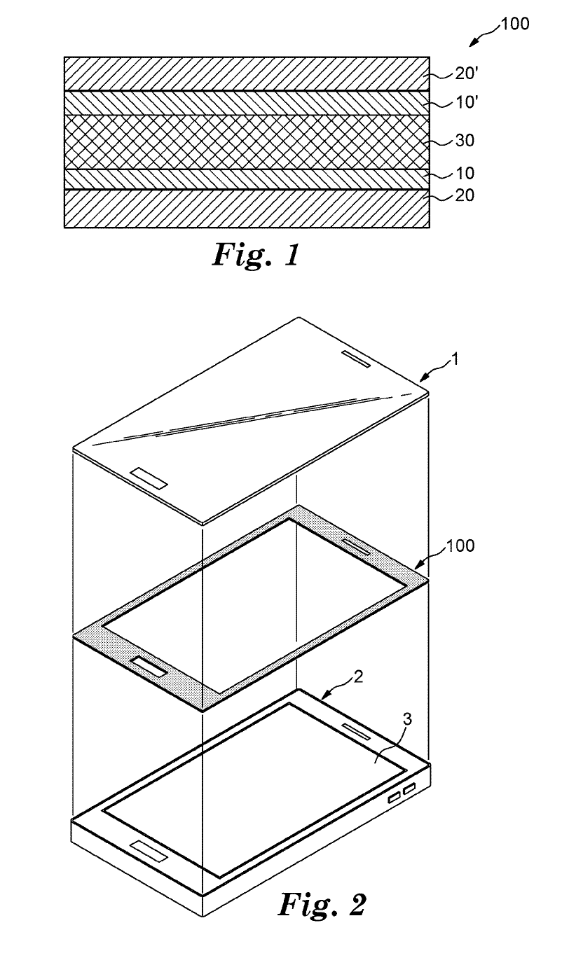

FIG. 1 shows a laminated structure of a double-sided tape 100 of an exemplary embodiment of the present invention.

Referring to FIG. 1, the double-sided tape 100 of the present exemplary embodiment may include a first adhesive layer 20, one or more film carrier layers, a second adhesive layer 20′ and a core adhesive layer 30 between the first adhesive layer 20 and the second adhesive layer 20′. Here, the above one or more film carrier layers may be a pair of film carrier layers, or a first film carrier layer 10 and a second film carrier layer 10′. In addition, the above first adhesive layer 20 and second adhesive layer 20′ may be adhesive layers that form both external surfaces of the double-sided tape 100, and they may be referred to as surface adhesive layers 20 and 20′.

The first film carrier layer 10 may be provided with the first adhesive layer 20 on one side and the second film carrier layer 10′ on the other side. The second adhesive layer 20′ may be provided next to the second film carrier layer 10′, but on the opposite side of the above first film carrier layer 10. Also, a core adhesive layer 30 may be provided between the first film carrier layer 10 and the second film carrier layer 10′. For example, the first film carrier layer 10 and the second film carrier layer 10′ may be disposed to face each other with the core adhesive layer 30 therebetween, the first adhesive layer 20 may be provided on the outer surface of the first film carrier layer 10, and the second adhesive layer 20′ may be provided on the outer surface of the second film carrier layer 10′.

For example, as shown in FIG. 1, the double-sided tape 100 may be a structure made up of a first adhesive layer 20, a first film carrier layer 10, a core adhesive layer 30, a second film carrier layer 10′ and a second adhesive layer 20′, which are laminated in that order. Alternatively, although not shown in the drawing, one or more additional layers may be interposed between any pair of layers.

The above double-sided tape 100 may be used to bond two components to each other. For this, the first adhesive layer 20 may be in contact with any one of the components, and the second adhesive layer 20′ may be in contact with the other component.

Also, the double-sided tape 100 may be provided or distributed with a release liner, which can be easily separated from either one or both of the first adhesive layer 20 and the second adhesive layer 20′, attached thereto. The release liner may be formed into a shape and a size that cover the whole area of the adhesive layer.

A double-sided tape that additionally includes a core adhesive layer as described above may exhibit excellent shock resistance when an external impact is applied, because the core adhesive layer which is provided in the middle absorbs the impact effectively. Moreover, the first adhesive layer and the second adhesive layer, which are provided on both surfaces of the double-sided tape, may exhibit excellent adhesive strength. By additionally including a core adhesive layer as in the present exemplary embodiment, a double-sided tape may have an improved shock resistance while retaining its excellent bonding property and be economical at the same time.

Each of the aforementioned first adhesive layer 20, first film carrier layer 10, core adhesive layer 30, second film carrier layer 10′ and second adhesive layer 20′ may have a thickness in the range of 30 to 100 μm, 1.4 to 100 μm, 50 to 200 μm, 1.4 to 100 μm and 30 to 100 μm, respectively. Preferably, the thicknesses of the first adhesive layer 20, the first film carrier layer 10, the core adhesive layer 30, the second film carrier layer 10′ and the second adhesive layer 20′ are 50 μm, 38 μm, 130 μm, 38 μm and 50 μm, respectively.

In addition, the double-sided tape 100 may have a thickness in the range of 150 to 360 μm in total. Preferably, the thickness of the double-sided tape 100 is in the range of 300 to 310 μm. More preferably, the thickness of the double-sided tape 100 is 306 μm. In this case, the sum of the thicknesses of the pair of adhesive layers and the film carrier layer may be set as a constant value. For example, the constant value may be in the range of 80 μm to 90 μm.

Hereinafter, each layer constituting the double-sided tape 100 of the present exemplary embodiment will be described in detail. If necessary, each of the layers to be described hereinafter may additionally contain various additives.

Film Carrier Layer (First and Second Film Carrier Layers)

A film carrier layer is a film-type sheet and may be a film-type plastic material. The ease of cutting and processing a double-sided tape 100 into a desirable shape and size may be attributed to the film carrier layer.

Specific examples of a plastic material that constitutes a film carrier layer may include: an acryl-based resin, such as a poly(methyl methacrylate) (PMMA); a polyester such as a polyethylene terephthalate (PET); polycarbonate (PC); a norbornene-based resin; an olefin polymer; and cellulose triacetate (TAC). The plastic material may be used alone or in combination with one or more of the other listed plastic materials. A PET film is preferably used as the film carrier layer in the present exemplary embodiment. Also, a highly transparent film or a black opaque film may be used.

Here, the film carrier layer may have a thickness in the range of 1.4 to 100 μm. When the thickness of the film carrier layer exceeds 100 μm, the stiffness of the double-sided tape 100 allows the object(s) to be adhered to be easily separated when an external impact is applied. 1.4 μm is the minimum thickness of the film carrier layer at which the double-sided tape 100 can be processed (converted) into a desirable shape and the double-sided tape 100 being prepared does not crease. Therefore, it is difficult to prepare and process a double-sided tape 100 if the thickness of the film carrier layer is less than the above minimum thickness. Preferably, the thickness of each of the first film carrier layer 10 and the second film carrier layer 10′ is in the range of 30 to 40 μm. More preferably, the thickness of each of the first film carrier layer 10 and the second film carrier layer 10′ is 38 μm.

Meanwhile, when a black opaque film is used, the film carrier layer may have a printed layer of a black ink formed on either one or both sides. FIG. 1 illustrates an example in which a printed layer is formed on one side of each of the first film carrier layer 10 and the second film carrier layer 10′. The printed layer may also be formed on both sides of the first film carrier layer 10 or second film carrier layer 10′.

Also, the film carrier layer may be primer-treated on either one or both sides. Alternatively, the aforementioned printed layer formed on one side of the film carrier layer may be subjected to a primer treatment. The primer treatment may improve an adhesive force between the film carrier layer and core adhesive layer 30, or between the surface adhesive layers (the first and second adhesive layers, 20 and 20′). Specifically, the primer treatment may be performed using urethane that contains either one or both of carbon black and silica, or using a primer that contains an acrylic resin. Also, the primer treatment may be performed by a gravure or micro gravure coating method.

The first film carrier layer 10 and the second film carrier layer 10′ have the above-described properties, and may be identical to or different from each other. For example, the first film carrier layer 10 and the second film carrier layer 10′ may be made up of the same material and have identical thicknesses; may be made up of the same material but have different thicknesses; or may be made up of different materials and have identical or different thicknesses. When the first film carrier layer 10 and the second film carrier layer 10′ are different from each other, the properties of each layer may be determined according to the types of the first adhesive layer 20 and the second adhesive layer 20′.

Surface Adhesive Layer (First and Second Adhesive Layers)

The surface adhesive layers 20 and 20′, each of which is provided on one side of the aforementioned film carrier layer, together forming the external surfaces of a double-sided tape 100, may be formed of a polymer composition that constitutes a pressure sensitive adhesive (PSA). When surface adhesive layers 20 and 20′ are in contact with the object(s) to be attached and a pressure is applied thereon, the double-sided tape 100 may be able to strongly adhere to the object(s) to be attached.

It is important that the surface adhesive layers 20 and 20′ have sufficiently good surface adhesion properties, and the material properties of the surface adhesive layers 20 and 20′ function as main factors that determine an adhesive strength with respect to an object(s) to be adhered. Each of the surface adhesive layers 20 and 20′ of the present exemplary embodiment may have a glass transition temperature in the range of −20 to 20° C.

A specific exemplary ingredient for a PSA that is required to form the above surface adhesive layers 20 and 20′ may be an acryl-based, silicone-based, polyester-based, rubber-based or polyurethane-based polymer. The ingredient for a PSA may be used for a surface adhesive composition, either alone or in combination with one or more other listed substances. In the present exemplary embodiment, a composition that consists of one or more acryl-based polymers is preferably used as the surface adhesive composition.

The above acryl-based polymer composition may be a polymer that is acquired through copolymerization using an acrylate-based compound as a main monomer ingredient. Needless to say, a copolymer that contains the above acrylate-based monomer as a first monomer and another monomer as a second monomer may also be used as the acryl-based polymer. According to one exemplary embodiment, the acrylate-based first monomer may contain an alkyl (meth)acrylate. Specifically, isooctyl acrylate (also known as IOA), 2-ethylhexyl acrylate (also known as 2-EHA) or butyl acrylate may be used as the first monomer; or it is also possible to use a combination of two or more listed compounds.

Specific examples of the second monomer that may be used together with the above acrylate-based monomer include: a styrene-based monomer, an olefin-based monomer, a vinyl ester, a cyano-group-containing monomer, an amide-group-containing monomer, a hydroxyl-group-containing monomer, an acidic-group-containing monomer, an epoxy-group-containing monomer, an amino-group-containing monomer, and a carboxyl-group-containing monomer.

According to one exemplary embodiment, the second monomer may be a monomer that contains an acidic group that is based on a vinyl carboxylic acid. Specifically, acrylic acid, methacrylic acid, itaconic acid, maleic acid, or a combination of 2 or more thereof may be used as the second monomer. In the present exemplary embodiment, a polymer composition required for the formation of surface adhesive layers 20 and 20′ may contain, as the monomers, an alkyl (meth)acrylate at 85 to 99 parts by weight and a vinyl carboxylic acid at 1 to 15 parts by weight. When the vinyl carboxylic acid content exceeds 15 parts by weight, the glass transition temperatures of the surface adhesive layers 20 and 20′ may increase, causing the surface wetting properties to degrade and the layers to become brittle enough to allow easy separation from the object(s) to be adhered when an external impact is applied. In contrast, when the vinyl carboxylic acid content is lower than 1 part by weight, the glass transition temperatures of the surface adhesive layers 20 and 20′ decrease, and thus it is difficult to maintain the surface adhesion properties and adhesive strength at sufficient levels required for adhesion.

Preferably, the surface adhesive composition contains, as the monomers, an alkyl (meth)acrylate at 90 parts by weight and a vinyl carboxylic acid at 10 parts by weight. In this case, isooctyl acrylate may be selected as the alkyl (meth)acrylate, and acrylic acid may be selected as the vinyl carboxylic acid.

A method that is well known in the art may be employed to prepare the above acryl-based polymer composition. For example, a solution polymerization method, an emulsion polymerization method, a self-polymerization method or a photopolymerization method using a photoinitiator may be used.

According to one exemplary embodiment of the present invention, a photopolymerization method that uses a photoinitiator as the polymerization initiator may be employed. A photopolymerization initiator that reacts to ultraviolet (UV) rays may be used as the photopolymerization initiator.

Also, the polymer composition required for the formation of the surface adhesive layers 20 and 20′ may further contain one or more crosslinkers and/or tackifiers.

The above crosslinker is a substance that is added to the polymer composition to cause a curing reaction, and basically may be able to retain a cohesive force of the polymer composition and prevent surface damage to an adhesive layer formed by the curing reaction. As the crosslinker, a commercially available product may be used; for example, a product of Cytec Industries Inc. based on hexanediol diacrylate (HDDA), a product of 3M Company based on 2,4-bis(trichloromethyl)-6-(3,4-dimethoxyphenyl)-1,3,5-triazine (XL353, U.S. Pat. No. 4,330,590) and/or a product of 3M Company based on 2,4-bis(trichloromethyl)-6-(4-methoxyphenyl)-1,3,5-triazine (XL330, U.S. Pat. No. 4,330,590) may be used.

According to an exemplary embodiment, the above crosslinker may be a triazine-containing crosslinker, where triazine may be contained at 0.05 to 0.4 parts by weight with respect to 100 parts by weight of the total monomer weight. Here, the crosslinker that contains triazine may be, for example, XL330 and/or XL353 from 3M Company. When the crosslinker content exceeds 0.4 parts by weight, an excessive curing reaction may occur, resulting in degradation of surface wetting properties of the surface adhesive layers 20 and 20′ and also allowing easy separation of the surface adhesive layers from the object(s) to be adhered when an external impact is applied. The crosslinker content of 0.05 parts by weight is the minimum composition ratio required to retain a cohesive force at a level that is sufficient for the initiation of the curing reaction, and when the crosslinker content (in terms of parts by weight) is lower than the above minimum composition ratio, a phenomenon in which the adhesive layer(s) is disturbed by rubbing, etc. at a high temperature may occur. Preferably, the crosslinker is contained in the polymer composition at 0.2 parts by weight with respect to 100 parts by weight of the monomers. Here, the above reference monomer may consist of, as described above, 85 to 99 parts by weight of an alkyl (meth)acrylate and 1 to 15 parts by weight of a vinyl carboxylic acid.

The aforementioned tackifier is a substance that is added to the polymer composition to give the composition an adhesive property. It may allow the composition to be well blended, and provide high-temperature holding performance and an adhesive property to the adhesive layer to be constructed. A commercially available product may also be used as the tackifier; for example, a product (YS polyester TH150) of Yasuhara Chemical Co., Ltd. based on a terpene phenolic copolymer may be used.

When a terpene phenolic copolymer is used as the tackifier, the tackifier may be contained at 5 to 50 parts by weight with respect to 100 parts by weight of the total monomer weight. When the tackifier content exceeds 50 parts by weight, the glass transition temperatures of the surface adhesive layers 20 and 20′ may increase, and thus the surface wetting properties may degrade and the surface adhesive layers may be easily separated from the object(s) to be adhered when an external impact is applied. In contrast, when the tackifier content is lower than 5 parts by weight, the glass transition temperatures of the surface adhesive layers 20 and 20′ decrease, and it is difficult to maintain the surface adhesion properties and adhesive strength at sufficient levels required for adhesion. Preferably, the tackifier is contained at 25 parts by weight with respect to 100 parts by weight of monomers. Again, the above reference monomer may consist of, as described above, 85 to 99 parts by weight of an alkyl (meth)acrylate and 1 to 15 parts by weight of a vinyl carboxylic acid.

Furthermore, if necessary, a crosslinker that is well known in the art may be used. In particular, a multifunctional acrylate or methacrylate, a multifunctional melamine compound, a multifunctional epoxy compound or a multifunctional isocyanate compound may be used. There is no particular limitation on the type of the crosslinker, and the crosslinker may be used either alone or in combination with one or more other types of listed crosslinkers. Also, if necessary, the polymer composition may contain various additives; for example, various additives that are well known in the art, such as common tackifying resins, plasticizers, fillers, colorants, UV absorbers and surfactants, may be added to the composition.

Meanwhile, the thicknesses of the surface adhesive layers 20 and 20′ may be in the range of 30 to 100 μm. When the thicknesses of the surface adhesive layers 20 and 20′ are less than 30 μm, it is difficult for the layers to exhibit sufficiently good adhesive properties. In contrast, when the thickness of each of the surface adhesive layers 20 and 20′ exceeds 100 μm, the core adhesive layer 30, which will be described below, is formed with a relatively small thickness, and thus the double-sided tape 100 may be easily separated from the object(s) to be adhered when an external impact is applied. Preferably, each of the first adhesive layer 20 and the second adhesive layer 20′, which are the surface adhesive layers 20 and 20′, has a thickness in the range of 50 to 70 μm. More preferably, the thickness of each of the first adhesive layer 20 and the second adhesive layer 20′, which are the surface adhesive layers 20 and 20′, is 50 μm.

The first adhesive layer 20 and the second adhesive layer 20′, which are the surface adhesive layers 20 and 20′, may be identical to or different from each other. For example, the first adhesive layer 20 and the second adhesive layer 20′ may have an identical thickness and be made of the same adhesive composition, may be made of the same adhesive composition but have different thicknesses, may have identical thicknesses but be made of different adhesive compositions, or may be made of different adhesive compositions and have different thicknesses. When the first adhesive layer 20 and the second film adhesive layer are different from each other, the properties of each layer may be determined according to the type of the object to be adhered to each of the first adhesive layer 20 and the second adhesive layer 20′.

In the present specification, adhesive compositions being the same may indicate that the compositions are identical in terms of both the types of the constituent materials and composition ratio. In contrast, adhesive compositions being different may indicate that the compositions are different from each other in terms of the type and number of the constituent materials, or in terms of the composition ratio but with the same types of constituent materials.

Core Adhesive Layer

The core adhesive layer 30, which is additionally included between the first adhesive layer 20 and the second adhesive layer 20′ of a double-sided tape 100, may also be formed of the polymer composition that contains ingredients for a PSA. The core adhesive layer 30 may be interposed between the first film carrier layer 10 and the second film carrier layer 10′ to bond the two film carrier layers together.

The core adhesive layer 30 functions as a main factor that determines susceptibility to separation (shock resistance) from the object(s) to be adhered of the double-sided tape 100 when an external impact is applied. Therefore, it may be made up of a polymer composition that is more effective in absorbing the impact as compared with the composition of the surface adhesive layers 20 and 20′, although the adhesive strength may not be higher. For example, the core adhesive layer 30 of the present exemplary embodiment may have a lower glass transition temperature in comparison to the surface adhesive layers 20 and 20′. For example, the core adhesive layer 30 may have a glass transition temperature in the range of −40 to −20° C.

Such a core adhesive layer 30 may be, like the surface adhesive layers 20 and 20′, made up of an acryl-based polymer composition. Specifically, the above acryl-based polymer composition is a polymer that is acquired through copolymerization using one or more acrylate-based compounds as the main monomer ingredient(s), an alkyl (meth)acrylate may be used as a first monomer, and a vinyl carboxylic acid may be used as a second monomer.

More specifically, the polymer composition for the formation of the core adhesive layer 30 may contain, as the monomers, an alkyl (meth)acrylate at 94 to 100 parts by weight and a vinyl carboxylic acid at 0 to 6 parts by weight. When the vinyl carboxylic acid content exceeds 10 parts by weight, the glass transition temperature of the core adhesive layer 30 increases, and thus the effectiveness of the core adhesive layer 30 in absorbing an external impact may be reduced. Preferably, the surface adhesive composition contains, as the monomers, an alkyl (meth)acrylate at 97 parts by weight and a vinyl carboxylic acid at 3 parts by weight. In this case, isooctyl acrylate may be selected as the alkyl (meth)acrylate, and acrylic acid may be selected as the vinyl carboxylic acid.

Also, the polymer composition for the formation of the above core adhesive layer 30 may contain at least one of crosslinkers and/or tackifiers. Since the properties of the crosslinker and tackifier are as described above in relation to the surface adhesive layers 20 and 20′ except the composition ratio thereof, further explanation will be omitted.

According to an exemplary embodiment, the polymer composition for the core adhesive layer 30 may contain, as the crosslinker, a triazine-containing crosslinker at 0.05 to 0.4 parts by weight with respect to 100 parts by weight of the total monomer weight. Here, the crosslinker that contains triazine may be, for example, XL330 and/or XL353 from 3M Company. When the crosslinker content exceeds 0.4 parts by weight, an excessive curing reaction may occur, resulting in reduced effectiveness of the core adhesive layer 30 in absorbing an external impact. In contrast, when the crosslinker content is lower than 0.05 parts by weight, the cohesive force may be reduced, resulting in cracks in the core adhesive layer 30 when an external impact is applied. Preferably, the above crosslinker is contained at 0.2 parts by weight with respect to 100 parts by weight of the monomers. Here, the above reference monomer may consist of, as described above, an alkyl (meth)acrylate at 94 to 100 parts by weight and a vinyl carboxylic acid at 0 to 6 parts by weight.

Also, the polymer composition for the core adhesive layer 30 may contain, as the tackifier, a terpene phenolic copolymer at 0 to 30 parts by weight with respect to 100 parts by weight of the total monomer weight. When the adhesive content exceeds 30 parts by weight, the glass transition temperature increases, resulting in reduced effectiveness of the core adhesive layer 30 in absorbing an external impact. Preferably, the above adhesive is contained at 15 parts by weight with respect to 100 parts by weight of the monomers. Again, the above reference monomer may consist of, as described above, an alkyl (meth)acrylate at 94 to 100 parts by weight and a vinyl carboxylic acid at 0 to 6 parts by weight.

The method of preparing the above acryl-based polymer composition and the additive(s) that may be added during the course of preparing the composition have been described above in relation to surface adhesive layers.

The core adhesive layer 30 may have a thickness in the range of 50 to 200 μm. When the thickness of the core adhesive layer 30 exceeds 200 μm, the adhesive strength of the core adhesive layer 30 decreases, and thus the core adhesive and film carrier layer may be easily separated from each other. Also, 50 μm is the minimum thickness required for the core adhesive layer 30 to be able to absorb an external impact sufficiently, and when the core adhesive layer is thinner than the minimum thickness, it is difficult to expect an improvement in the shock resistance of the double-sided tape 100. Preferably, the thickness of the core adhesive layer 30 is in the range of 120 to 130 μm. More preferably, the thickness of the core adhesive layer 30 is 130 μm.

In the present invention, the double-sided tape 100 may further include an additional layer(s) to the extent that does not impair the effects of the present invention.

When a double-sided tape having the above-described structure is used to bond two components together, the surface adhesive layers (the first adhesive layer and the second adhesive layer) of the double-sided tape may exhibit sufficient adhesive strength, and at the same time, the core adhesive layer may absorb any applied external impact, thus giving the tape shock resistance. Accordingly, occurrence of the phenomenon in which the adhesive system of two components bonded together by a double-sided tape is disrupted by an applied external impact may be significantly reduced. According to one exemplary embodiment, the double-sided tape of the present invention is economical, as it exhibits excellent shock resistance without including an additional foam-type base material. Therefore, the double-sided tape of the present invention may be usefully employed to bond components together in the manufacturing process of electronic devices, such as televisions, computers and mobile handsets, and may be able to improve the durability of the electronic devices and reduce the manufacturing costs.

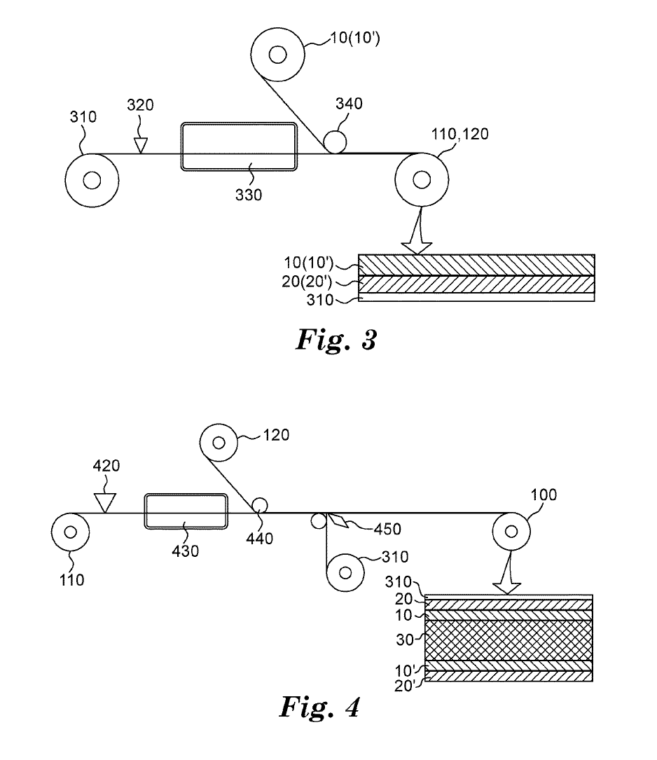

FIG. 2 is an exploded perspective view of one example of an electronic device that includes the above-described double-sided tape 100.

Referring to FIG. 2, the above double-sided tape 100 having the laminated structure of FIG. 1 may be used to bond the first component and the second component of the electronic device together. For this purpose, any one of the first adhesive layer 20 and the second adhesive layer 20′ of the double-sided tape 100 may be in contact with the first component, and the other one may be in contact with the second component. The double-sided tape 100 may include, as described above, an additional core adhesive layer 30 between the first adhesive layer 20 and the second adhesive layer 20′. Here, the core adhesive layer 30 is an additional adhesive layer that improves the shock resistance of the double-sided tape 100, and it may have a lower glass transition temperature in comparison to the first and second adhesive layers 20 and 20′. For example, the glass transition temperature of the core adhesive layer 30 may be in the range of −40° C. to −20° C.

In the present exemplary embodiment, the first component may consist of glass, and the second component may consist of a plastic or metal. For example, the second component may consist of any one of PC, magnesium, and stainless steel (SUS). When the first component and the second component are made up of different materials from each other as described above, the first adhesive layer 20 and the second adhesive layer 20′ of the double-sided tape may also be made differently to suit the properties of the material to which each of the adhesive layers adheres. For example, the first adhesive layer 20 may consist of a polymer composition that exhibits a strong surface adhesion force to a glass material, whereas the second adhesive layer 20′ may consist of a polymer composition that exhibits a strong surface adhesion force to a plastic. In this case, the first film carrier layer 10 and the second film carrier layer 10′ may also be made differently, depending on the composition of each of the first adhesive layer 20 and the second adhesive layer 20′, so that each different adhesive layer can adhere effectively to each of the above components.

According to one exemplary embodiment of the present invention, the above electronic device may be a mobile handset, and the first component may be tempered glass 1 that constitutes the front of the mobile handset. In addition, the second component may be a framing component 2 that is disposed behind the tempered glass and accommodates a display panel 3 at the interior. In this case, as illustrated in FIG. 2, the aforementioned double-sided tape 100 may be processed to have a shape with a narrow width.

In the present exemplary embodiment, the double-sided tape may be easily cut and processed to have a shape with a narrow width of 0.7 mm or less, owing to the film carrier layer that is included in the tape. At the same time, owing to the core adhesive layer that is interposed between the two film carrier layers, when an external impact is applied to the mobile handset (e.g., when it is dropped by the user), the double-sided tape may absorb the impact effectively and prevent the phenomenon in which the tempered glass or framing component is separated from the double-sided tape. In this way, the durability of mobile handset can be enhanced.

In addition, the present invention provides a method of preparing the aforementioned double-sided tape 100.

Each of FIG. 3 and FIG. 4 schematically illustrates an exemplary embodiment of the method of preparing the aforementioned double-sided tape.

Referring to FIG. 3, the method of preparing the double-sided tape may include forming the first part 110 and the second part 120, each of which has a laminated structure including a film carrier layer and a surface adhesive layer.

Here, the first adhesive layer and the second adhesive layer may be referred to as the surface adhesive layers 20 and 20′. Also, the first part 110 and the second part 120 may refer to intermediate products that are prepared by the process of FIG. 3 and have the laminated structure of FIG. 3. As illustrated in the lower right-hand side of FIG. 3, each of the first part 110 and the second part 120 may include one of the film carrier layers 10 and 10′ and one of the surface adhesive layers 20 and 20′ laminated on one side. Each of the first part 110 and the second part 120 may additionally include a release liner 310 that is attached to an external surface of the surface adhesive layer.

Specifically, to prepare each of the first part 110 and the second part 120, first of all, a surface adhesive composition for the formation of the surface adhesive layers 20 and 20′ may be applied at a thickness in the range of 30 μm to 100 μm (320). In this case, the surface adhesive composition may be applied on the release liner 310. For this, a wrapping roll 310 of the release liner is provided at the front end of the production line, and as the wrapping roll 310 of the above release liner is unrolled, the surface adhesive composition may be applied with a knife coater on the film.

Then, the applied surface adhesive composition may be cured by UV rays (330). For this, the UV rays may be radiated to the surface adhesive composition. For example, the UV curing of the surface adhesive composition may be carried out through a first operation of radiating UVA with an intensity of 2.21 mW/cm² for 45 seconds, a second operation of radiating UVA with an intensity of 9.1 mW/cm² for 50 seconds, and a third operation of radiating UVC with an intensity of 18 mW/cm² for 10 seconds.

Each of the first part 110 and the second part 120 may be prepared by laminating the film carrier layer on the cured surface adhesive composition at the pressure in the range of 10 kgf to 50 kgf (340). For this, a wrapping roll 10 or 10′ of the film carrier layer is provided in the middle of the production line, and as the wrapping roll of the film carrier layer is unrolled, the film may be disposed on the cured surface adhesive composition. At this time, lamination may be performed by pressing the film carrier layer from the top at the above-described pressure. The film carrier layer may have a black printed layer formed on either one or both sides and may be primer-treated on either one or both of its surfaces.

The above-described operations may be carried out at a line speed of 20 to 60 m/min.

The method of preparing the first part 110 and the second part 120 is not intended to limit the spirit of the present invention. The first part 110 and the second part 120 may also be prepared by other conventional methods of preparing an adhesive tape. For example, a surface adhesive layer may be prepared by applying a surface adhesive composition directly on one side of a film carrier layer, without a laminating process.

Referring to FIG. 4, the above-described double-sided tape may be prepared by preparing a first part 110 and a second part 120 in the above-described manner and then laminating the first part 110 and the second part 120, with a core adhesive layer 30 disposed therebetween.

Specifically, first of all, a core adhesive composition may be applied on the external surface of the film carrier layer of the first part 110 (420). For this, a wrapping roll 110 of the first part may be provided at the front end of the production line. As the wrapping roll 110 of the first part is unrolled, the core adhesive composition may be applied on the film carrier layer 10 or 10′ of the first part. The core adhesive composition may be applied with a knife coater, and it may be applied at a thickness in the range of 50 μm to 200 μm.

Then, the core adhesive layer 30 may be prepared by curing the applied core adhesive composition (430). In this case, the curing of the core adhesive composition may be carried out by radiating UV rays to the core adhesive composition. According to one exemplary embodiment, the UV curing of the core adhesive composition may be carried out through a first operation of radiating UVA with an intensity of 2.21 mW/cm² for 75 seconds, a second operation of radiating UVA with an intensity of 4 mW/cm² for 100 seconds, and a third operation of radiating UVC with an intensity of 18 mW/cm² for 16 seconds.

A double-sided tape 100 may be formed by laminating, on the above core adhesive layer 30, the film carrier layer 10′ or 10 of the second part 120 that has already been prepared. For example, the film carrier layer of the second part may be brought into contact and laminated (440), at a pressure in the range of 10 kgf to 50 kgf, with the core adhesive layer. For this, a wrapping roll 120 of the second part prepared through the process of FIG. 3 may be provided in the middle of the production line, and the film may be disposed on the core adhesive layer as the wrapping roll of the second part is unrolled. In this case, the second part 120 may be disposed in contact with the core adhesive layer 30 with the film carrier layer 10′ or 10 facing downward.

Additionally, a wrapping roll 100 of the double-sided tape may be prepared by removing the release liner 310 of any one of the first part 110 and the second part 120 (450) and rolling the laminated structure in one direction.

The above operations may be carried out at a line speed of 10 to 40 m/min.

According to the preparation method of the present exemplary embodiment, a double-sided tape 100 with the above-described structure may be easily prepared by preparing two intermediate products through an identical preparation process and then bonding the two intermediate products 110 and 120 together using the core adhesive layer 30. According to the present exemplary embodiment, the preparation process may be simplified, thus reducing the manufacturing cost.

Hereinafter, the present invention will be described in further detail with reference to the following exemplary embodiments. However, the following exemplary embodiments are intended merely to illustrate the present invention, and the scope of the present invention is not limited thereto.

### Comparative Example and Examples 1 to 17

To prepare a polymer composition for the construction of the first and second adhesive layers 20 and 20′, which are the surface adhesive layers, surface adhesive composition samples were prepared to have the compositions shown in the following Table 1. In the following Table 1, the content of each substance is expressed as the relative weight with respect to 100 parts by weight of the total monomer weight. As the monomer, two types of acryl-based monomers were used in combination.

TABLE 1

| | First | Second | | | | | Glass transition |
|---|---|---|---|---|---|---|---|
| Sample | monomer | monomer | Crosslinker | | | Tackifier | temperature |
| number | IOA | AA | HDDA | XL330 | XL353 | TH150 | (° C.) |
| 4-5-D | 99 | 1 | 0.05 | 0.2 | | 25 | −14.91 |
| 4-5-E | 99 | 1 | 0.05 | 0.25 | | 30 | −10.66 |
| 4-5-F | 99 | 1 | 0.05 | 0.13 | | 20 | −20.5 |
| 4-5-G | 99 | 1 | 0.05 | 0.35 | | 40 | −2.43 |
| 4-5-H | 99 | 1 | 0.05 | 0.45 | | 50 | 5.27 |
| 4-5-I | 99 | 1 | 0.03 | 0.15 | | 20 | −20.38 |
| 4-5-J | 99 | 1 | 0.05 | 0.2 | | 30 | −10.66 |
| 4-5-K | 99 | 1 | 0.05 | 0.3 | | 35 | −6.48 |
| 3-10-A | 97 | 3 | 0.03 | 0.13 | | 15 | −21.0 |
| 3-10-B | 97 | 3 | 0.03 | 0.15 | | 20 | −14 |
| 3-10-C | 97 | 3 | 0.03 | 0.2 | | 27 | −8.17 |
| 3-10-D | 97 | 3 | 0.05 | 0.2 | | 32 | −2.83 |
| 3-10-E | 97 | 3 | 0.03 | 0.1 | | 15 | −21 |
| 3-10-F | 97 | 3 | 0.05 | 0.3 | | 40 | 3.17 |
| 14-1 | 93 | 7 | 0.03 | 0.15 | | 20 | −6 |
| 14-2 | 93 | 7 | 0.05 | 0.2 | | 30 | 3.14 |
| 14-3 | 93 | 7 | | | 0.2 | 25 | −1.44 |
| 14-4 | 93 | 7 | | | 0.15 | 20 | −6 |
| 14-3-A | 93 | 7 | | | 0.13 | 25 | −1.44 |
| 14-3-B | 93 | 7 | | | 0.1 | 25 | −1.44 |
| 15-1 | 90 | 10 | 0.03 | 0.2 | | 25 | 5.7 |
| 15-2 | 90 | 10 | 0.03 | 0.15 | | 20 | 1.1 |
| 15-3 | 90 | 10 | | | 0.1 | 25 | 5.7 |
| 15-4 | 90 | 10 | | 0.1 | | 25 | 5.7 |
| 15-5 | 90 | 10 | | | 0.2 | 25 | 5.7 |
| 16-1 | 96 | 4 | | | 0.15 | 20 | −13.2 |
| 16-1-A | 96 | 4 | | | 0.1 | 20 | −13.2 |

Meanwhile, as the core adhesive layer 30, core adhesive composition samples were prepared to have the compositions shown in the following Table 2. Again, the content of each substance is expressed in the following Table 2 as the relative weight with respect to 100 parts by weight of the total monomer weight, and as the monomer, two types of acryl-based monomers were used in combination.

TABLE 2

| | First | Second | | | | | Glass transition |
|---|---|---|---|---|---|---|---|
| Sample | monomer | monomer | Crosslinker | | | Tackifier | temperature |
| number | IOA | AA | HDDA | XL330 | XL353 | TH150 | (° C.) |
| Core10 | 99 | 1 | | | 0.15 | | −38.6 |
| Core15 | 98.5 | 1.5 | | | 0.1 | | −37.4 |
| Core20 | 98 | 2 | | | 0.15 | | −36.2 |
| Core20-1 | 98 | 2 | | | 0.1 | | −36.2 |
| Core30 | 97 | 3 | | | 0.1 | | −33 |
| Core30-1 | 97 | 3 | | | 0.2 | 15 | −21 |
| Core40 | 96 | 4 | | | 0.1 | | −31 |

The information on the substances used in the above Table 1 and Table 2 is provided in the following Table 3.

TABLE 3

| Name | Type | Provider | Note |
|---|---|---|---|
| IOA | Monomer | 3M | Isooctyl acrylate |
| AA | Monomer | LG Chemical | Acrylic acid |
| HDDA | Crosslinker | Cytec | Hexanediol diacrylate |
| XL330 | Crosslinker | 3M | 2,4-Bis(trichloromethyl)-6- |
| | | | (3,4-dimethoxyphenyl)-1,3,5- |
| | | | triazine |
| XL353 | Crosslinker | 3M | 2,4-Bis(trichloromethyl)-6-(4- |
| | | | methoxyphenyl)-1,3,5-triazine |
| TH150 | Tackifier | Yasuhara | Terpene phenolic copolymer |
| | | Chemical | |

Also, film carrier layer samples (described in the following Table 4) were prepared using PET films as the first and second film carrier layers 10 and 10′.

TABLE 4

| Sample number | Thickness | Black printed layer | Primer treatment |
|---|---|---|---|
| PET 1 | 4.5 μm | One side | Both sides |
| PET 2 | 12 μm | One side | Both sides |
| PET 3 | 25 μm | One side | Both sides |
| PET 4 | 38 μm | Both sides | One side |
| PET 5 | 50 μm | Both sides | None |

Samples from the above Tables 1, 2 and 4 were used in combination as described in the following Table 5 to prepare double-sided tape Samples 1 to 17 according to Examples 1 to 17. The first and second adhesive layers, which are surface adhesive layers, were prepared using an identical surface adhesive composition sample as the polymer composition. Similarly, the first and second film carrier layers were prepared using an identical film carrier layer sample.

TABLE 5

| | Surface adhesive layer | Core adhesive layer | Film carrier |
|---|---|---|---|
| Example | composition sample | composition sample | layer sample |
| Sample 1 | 15-1 | Core 10 | PET 3 |
| Sample 2 | 15-1 | Core 10 | PET 5 |
| Sample 3 | 15-1 | Core 40 | PET 5 |
| Sample 4 | 15-1 | Core 40 | PET 3 |
| Sample 5 | 15-1 | Core 15 | PET 4 |
| Sample 6 | 15-1 | Core 20-1 | PET 4 |
| Sample 7 | 15-1 | Core 40 | PET 4 |
| Sample 8 | 15-5 | Core30-1 | PET 4 |
| Sample 9 | 15-3 | Core 15 | PET 4 |
| Sample 10 | 14-2 | Core 40 | PET 1 |
| Sample 11 | 14-3 | Core 20-1 | PET 4 |
| Sample 12 | 14-4 | Core 20-1 | PET 4 |
| Sample 13 | 14-3 | Core 40 | PET 4 |
| Sample 14 | 14-3-A | Core 40 | PET 4 |
| Sample 15 | 14-3-B | Core 40 | PET 4 |
| Sample 16 | 16-1 | Core 40 | PET 4 |
| Sample 17 | 16-1-A | Core 40 | PET 4 |

Specifically, the ingredients of the corresponding surface adhesive composition sample were blended and applied with a knife coater and at a line speed of 40 m/min on the release liner at a thickness of 50 μm for the formation of the first and second adhesive layers 20 and 20′. UV rays were radiated to the applied substances for curing, and the substances were brought into a contact and laminated, at a pressure of 20 kgf, with the corresponding film carrier layer sample. The UV irradiation was performed in three zones as shown in the following Table 6.

TABLE 6

| | Zone 1 | Zone 2 | Zone 4 |
|---|---|---|---|
| UV types | UVA | UVA | UVC |
| Intensity (mW/cm²) | 2.21 | 9.1 | 18 |
| Residence time (s) | 45 | 50 | 10 |

Subsequently, to form the core adhesive layer 30, the ingredients of the corresponding core adhesive composition sample were blended, and the composition was applied at a thickness of 130 μm on the film carrier layer sample (the first part), on which the surface adhesive layer had been previously formed, using a knife coater and at a line speed of 20 m/min. Then, UV rays were radiated to the applied layer for curing, and the cured substances were brought into a contact and laminated, at a pressure of 30 kgf, with the film carrier layer sample (the second part), on which a surface adhesive layer had been previously formed. The UV irradiation was performed in three zones as shown in the following Table 7.

TABLE 7

| | Zone 1 | Zone 2 | Zone 4 |
|---|---|---|---|
| UV types | UVA | UVA | UVC |
| Intensity (mW/cm²) | 2.21 | 4 | 18 |
| Residence time (s) | 75 | 100 | 16 |

Meanwhile, in the comparative example, PET 5 was used as the film carrier layer sample, and 3-10-C was used as the surface adhesive layer sample. The adhesive layer (3-10-C) was applied at a thickness of 125 μm on each of both sides of the film carrier layer (PET 5). As in the laminated structure of conventional double-sided tapes, a core adhesive layer was not applied in the comparative example.

<Evaluation>

A shock resistance (drop energy) measurement test and an adhesive strength (push-out strength) measurement test were performed on each of the Samples 1 to 17 that had been prepared according to the comparative example and Examples 1 to 17.

The drop energy measurement test was conducted by preparing a specimen by bonding two components with the double-sided tape to be measured, attaching a weight having a predetermined weight to one of the components, and dropping the weight from a predetermined height so that the weight fell in the direction in which the above two components were separated from each other. When the impact applied by the weight broke apart the above specimen, the weight of the weight and height from which the weight was dropped were measured to determine the magnitude of the energy that the double-sided tape can tolerate. A greater magnitude of the measured energy indicates that the double-sided tape can absorb a larger impact, and thus the magnitude of the measured energy may be used as the parameter that determines the drop energy of the double-sided tape. Furthermore, the failure mode of the above specimen was observed and recorded.

The push-out strength measurement test was carried out by preparing a specimen by bonding two components with the double-sided tape to be measured and pushing, with a spherical probe, either of the two components in a direction in which the component is separated from the double-sided tape. The push-out strength of the double-sided tape was determined by measuring the force at which the spherical probe pushed the specimen to break it apart. Furthermore, also in the present test, the failure mode of the above specimen was observed and recorded.

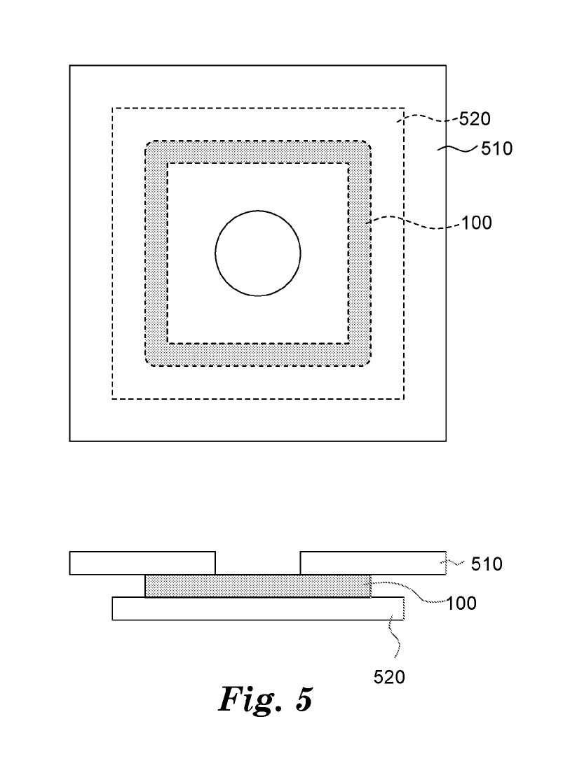

The specimen of FIG. 5 was used for the drop energy measurement test and the push-out strength measurement test. Referring to FIG. 5, a double-sided tape 100 was used to bond a PC substrate 510 and a tempered glass substrate 520 together. The PC substrate 510 was formed to have a width, length and thickness of 50 mm, 50 mm and 2 mm, respectively, and a through hole having a diameter of 10 mm was formed in the center. The tempered glass substrate 520 was formed to have a width, length and thickness of 25 mm, 25 mm and 2 mm, respectively. Also, the double-sided tape 100 was formed into a square rim having the overall width and length of 20 mm and 20 mm, respectively, and width of the rim was 2 mm. The surface adhesive layers 20 and 20′ on both sides of the double-sided tape 100 were brought into contact with the PC substrate 510 and tempered glass substrate 520, respectively, and pressed for 1 hour at a pressure of 3 kgf for adhesion. With the above specimen, the drop energy was measured by dropping a weight through the through hole formed in the PC substrate 510 onto the tempered glass substrate 520, and the push-out strength was measured by pushing the tempered glass substrate 520 away from the double-sided tape through the above through hole.

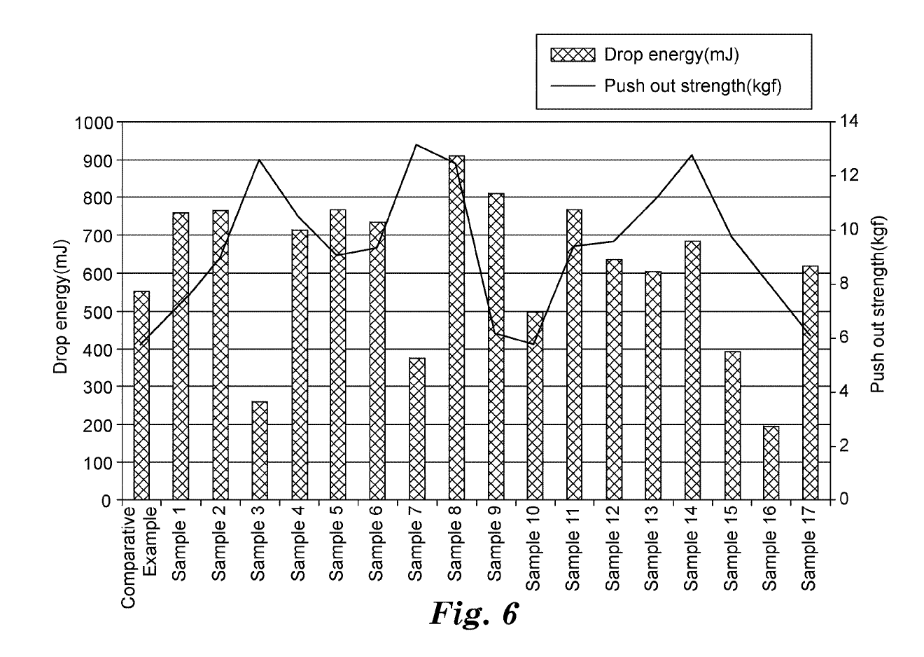

The results are summarized in the following Table 8 and illustrated in the graph of FIG. 6.

TABLE 8

| | | | Push- | |
|---|---|---|---|---|
| | Drop | | out | |
| | energy | | strength | |
| | (mJ) | Failure mode | (kgf) | Failure mode |
| Com- | 550 | Both substrates cleanly | 5.8 | Surface adhesive |
| parative | | separated from tape | | layer split in |
| example | | | | half |
| Sam- | 760 | Core adhesive layer | 7.24 | Core adhesive layer |
| ple 1 | | separated from film | | separated from film |
| | | carrier layer | | carrier layer |
| Sam- | 767 | Core adhesive layer | 9 | Core AP |
| ple 2 | | separated from film | | |
| | | carrier layer | | |
| Sam- | 261 | Tempered glass | 12.6 | Core adhesive layer |
| ple 3 | | substrate cleanly | | separated from film |
| | | separated from tape | | carrier layer |
| Sam- | 712 | Core adhesive layer | 10.51 | Core adhesive layer |
| ple 4 | | separated from film | | split in half |
| | | carrier layer | | |
| Sam- | 767 | Core adhesive layer | 9.1 | Core adhesive layer |
| ple 5 | | separated from film | | separated from film |
| | | carrier layer | | carrier layer |
| Sam- | 735 | Core adhesive layer | 9.36 | Core adhesive layer |
| ple 6 | | separated from film | | separated from film |
| | | carrier layer | | carrier layer |
| Sam- | 375 | Tempered glass | 13.2 | Core adhesive layer |
| ple 7 | | substrate cleanly | | split in half |
| | | separated from tape | | |
| Sam- | 910 | Core adhesive layer | 12.5 | Core adhesive layer |
| ple 8 | | split in half | | split in half |
| Sam- | 810 | Core adhesive layer | 6.2 | Core adhesive layer |
| ple 9 | | split in half | | separated from film |
| | | | | carrier layer |
| Sam- | 500 | Surface adhesive layer | 5.8 | Core adhesive layer |
| ple 10 | | separated from film | | split in half |
| | | carrier layer | | |
| Sam- | 767 | Core adhesive layer | 9.43 | Core adhesive layer |
| ple 11 | | separated from film | | separated from film |
| | | carrier layer | | carrier layer |
| Sam- | 637 | Core adhesive layer | 9.6 | Core adhesive layer |
| ple 12 | | separated from film | | separated from film |
| | | carrier layer | | carrier layer |
| Sam- | 604 | Tempered glass | 11.05 | Core adhesive layer |
| ple 13 | | substrate cleanly | | separated from film |
| | | separated from tape; | | carrier layer |
| | | core adhesive layer | | |
| | | separated from film | | |
| | | carrier layer | | |
| Sam- | 686 | Tempered glass | 12.8 | Core adhesive layer |
| ple 14 | | substrate cleanly | | split in half |
| | | separated from tape; | | |
| | | core adhesive layer | | |
| | | split in half | | |
| Sam- | 392 | Polycarbonate | 9.78 | Core adhesive layer |
| ple 15 | | substrate cleanly | | split in half |
| | | separated from tape | | |
| Sam- | 196 | Tempered glass | 7.95 | Tempered glass |
| ple 16 | | substrate cleanly | | substrate cleanly |
| | | separated from tape | | separated from tape |
| Sam- | 620 | Tempered glass | 6.13 | Tempered glass |
| ple 17 | | substrate cleanly | | substrate cleanly |
| | | separated from tape; | | separated from tape |
| | | core adhesive layer | | |
| | | split in half | | |

As shown in Table 8 and FIG. 6, it could be recognized that Samples 1 to 17 had higher shock resistance and/or adhesive strength in comparison to the comparative example. However, generally, higher shock resistance correlated with relatively low adhesive strength (e.g. Sample 5), and high adhesive strength correlated with relatively low shock resistance (e.g. Sample 7). In contrast, Samples 2, 5, 6, 8, 13, etc. were observed to exhibit both high shock resistance and high adhesive strength. In particular, it could be observed that Sample 8 had considerably high shock resistance and adhesive strength.

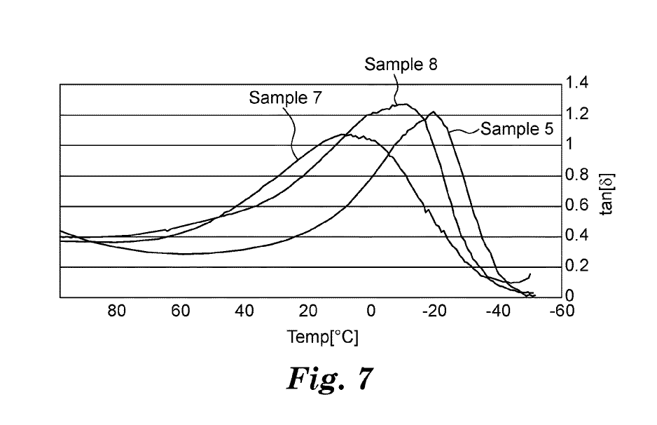

Furthermore, Sample 5, Sample 7 and Sample 8 were measured using a rheology meter for their rheology properties in response to temperature variation. A tan(δ) value with respect to temperature was measured as the rheology property. tan(δ) is the ratio of loss modulus to elastic modulus and is the parameter of the damping effect of a particular substance. A large tan(δ) value indicates that the particular substance can absorb a large amount of energy at the corresponding temperature. The results of the rheology property measurement are illustrated in the graph of FIG. 7.

Referring to FIG. 7, Sample 8 exhibits a larger tan(δ) value over a wide temperature range (about −20 to 10° C.) compared with Sample 5 and Sample 7. Therefore, it can again be identified that Sample 8 basically exhibits high shock resistance while having high adhesive strength.

The following is a list of exemplary embodiments of the present invention.

Item 1 is a double-sided tape that includes a double-sided tape structure including, in order, a first adhesive layer, one or more film carrier layers and a second adhesive layer, and a core adhesive layer between the first adhesive layer and the second adhesive layer.

Item 2 is the double-sided tape of Item 1, where the thickness of each of the first adhesive layer and the second adhesive layer is 30 μm to 100 μm.

Item 3 is the double-sided tape of Item 1 and Item 2, where the thickness of each of the first adhesive layer and the second adhesive layer is 50 μm.

Item 4 is the double-sided tape of Item 1 to Item 3, where each of the first adhesive layer and the second adhesive layer is an adhesive layer consisting of an acryl-based polymer.

Item 5 is the double-sided tape of Item 1 to Item 4 consisting of an adhesive composition, where either one or both of the first adhesive layer and the second adhesive layer contain(s): a) an alkyl (meth)acrylate at 85 to 99 parts by weight; b) a vinyl carboxylic acid at 1 to 15 parts by weight; c) a triazine-containing crosslinker at 0.05 to 0.4 parts by weight with respect to 100 parts by weight of a) plus b); and d) a terpene phenolic copolymer at 5 to 50 parts by weight with respect to 100 parts by weight of a) plus b).

Item 6 is the double-sided tape of Item 5, where a) is contained at 90 parts by weight, b) is contained at 10 parts by weight, c) is contained at 0.2 parts by weight with respect of 100 parts by weight of a) plus b), and d) is contained at 25 parts by weight with respect to 100 parts by weight of a) plus b).

Item 7 is the double-sided tape of Item 1 to Item 6, where the alkyl (meth)acrylate includes at least one of isooctyl acrylate, 2-ethylhexyl acrylate and butyl acrylate, and the vinyl carboxylic acid includes at least one of acrylic acid, methacrylic acid, itaconic acid and maleic acid.

Item 8 is the double-sided tape of Item 1 to Item 7, where the first adhesive layer and the second adhesive layer are formed of different adhesive compositions from each other.

Item 9 is the double-sided tape of Item 1 to Item 8, where the film carrier layers are provided as a pair, and the core adhesive layer is interposed between the pair of film carrier layers.

Item 10 is the double-sided tape of Item 1 to Item 9, where the first adhesive layer, any one of the pair of film carrier layers, the core adhesive layer, the other one of the pair of film carrier layers and the second adhesive layer are laminated in the written order.

Item 11 is the double-sided tape of Item 1 to Item 10, where the thickness of each of the film carrier layers is 1.7 μm to 100 μm.

Item 12 is the double-sided tape of Item 1 to Item 11, where the thickness of each of the film carrier layers is 38 μm.

Item 13 is the double-sided tape of Item 1 to Item 12, where each of the film carrier layers is a PET carrier layer.

Item 14 is the double-sided tape of Item 1 to Item 13, where at least one side of each of the film carrier layers has a primer layer formed thereon.

Item 15 is the double-sided tape of Item 1 to Item 14, where the thickness of the core adhesive layer is 50 μm to 200 μm.

Item 16 is the double-sided tape of Item 1 to Item 15, where the thickness of the core adhesive layer is 130 μm.

Item 17 is the double-sided tape of Item 1 to Item 16, where the core adhesive layer consists of an acryl-based polymer.

Item 18 is the double-sided tape of Item 1 to Item 17, where the core adhesive layer consists of an adhesive composition that contains: a) an alkyl (meth)acrylate at 94 to 100 parts by weight; b) a vinyl carboxylic acid at 0 to 6 parts by weight; c) a triazine-containing crosslinker at 0.05 to 0.4 parts by weight with respect to 100 parts by weight of a) plus b); and d) a terpene phenolic copolymer at 0 to 30 parts by weight with respect to 100 parts by weight of a) plus b).

Item 19 is the double-sided tape of Item 18, where the core adhesive layer contains a) at 97 parts by weight, b) at 3 parts by weight, c) at 0.2 parts by weight with respect to 100 parts by weight of a) plus b), and d) at 15 parts by weight with respect to 100 parts by weight of a) plus b).

Item 20 is the double-sided tape of Item 1 to Item 19, where the alkyl (meth)acrylate includes at least one of isooctyl acrylate, 2-ethylhexyl acrylate and butyl acrylate, and the vinyl carboxylic acid includes at least one of acrylic acid, methacrylic acid, itaconic acid and maleic acid.

Item 21 is the double-sided tape of Item 1 to Item 20, where the core adhesive layer has a lower glass transition temperature in comparison to the first and second adhesive layers.

Item 22 is the double-sided tape of Item 1 to Item 21, where the glass transition temperature of the core adhesive layer is in the range of −40° C. to −20° C.

Item 23 is the double-sided tape of Item 1 to Item 22, where the double-sided tape has a thickness in the range of 300 μm to 310 μm, and the sum of the thickness of the film carrier layer and the thickness of the first or second adhesive layer is in the range of 80 μm to 90 μm.

Item 24 is the double-sided tape of Item 1 to Item 23, where the film carrier layer, the first adhesive layer, the second adhesive layer and the core adhesive layer have thicknesses of 38 μm, 50 μm, 50 μm and 130 μm, respectively.

Item 25 is a double-sided tape that includes a first film carrier layer; a first adhesive layer that is provided on one side of the first film carrier layer; a second film carrier layer that is provided on the other side of the first film carrier layer; a second adhesive layer that is provided next to the second film carrier layer but on the opposite side of the first film carrier layer; and a core adhesive layer that is provided between the first film carrier layer and the second film carrier layer.

Item 26 is the double-sided tape of Item 25, where the first adhesive layer adheres to one side of the first film carrier layer, and the second adhesive layer adheres to one side of the second film carrier layer.

Item 27 is the double-sided tape of Item 25 and Item 26, where one side of the core adhesive layer adheres to the first film carrier layer on the opposite side of the first adhesive layer, and the other side of the core adhesive layer adheres to the second film carrier layer on the opposite side of the second adhesive layer.

Item 28 is an electronic device that includes a first component, a second component and a double-sided tape that bonds the components together by having a first adhesive layer and a second adhesive layer on each side of the tape, where the double-sided tape further includes a core adhesive layer between the first adhesive layer and the second adhesive layer.

Item 29 is the electronic device of Item 28, where the core adhesive layer has a lower glass transition temperature as compared with the first and second adhesive layers.

Item 30 is the electronic device of Item 28 and Item 29, where the glass transition temperature of the core adhesive layer is in the range of −40° C. to −20° C.

Item 31 is the electronic device of Item 28 to Item 30, where the first component is made of glass, and the second component is made of a plastic or metal.

Item 32 is the electronic device of Item 28 to Item 31, where the second component is made of any one of PC, magnesium, and SUS.

Item 33 is the electronic device of Item 28 to Item 32, where the electronic device is a mobile handset, the first component is tempered glass that makes up the front of the mobile handset, and the second component is a framing component that is disposed behind the tempered glass.

Item 34 is a method of preparing a double-sided tape that includes an operation of forming a first part and a second part, each of which has a laminated structure of a film carrier layer and a surface adhesive layer; an operation of applying a core adhesive composition on an external surface of the film carrier layer of the first part; an operation of forming a core adhesive layer by curing the core adhesive composition; and an operation of laminating the film carrier layer of the second part on the core adhesive layer.

Item 35 is the method of preparing a double-sided tape of Item 34, where the operation of forming the first part and the second part includes an operation of applying, at a thickness ranging from 30 μm to 100 μm, a surface adhesive composition for the formation of the surface adhesive layer; an operation of UV curing the applied surface adhesive composition; and an operation of laminating, with a pressure ranging from 10 kgf to 50 kgf, the film carrier layer on the cured surface adhesive composition.

Item 36 is the method of preparing a double-sided tape of Item 34 and Item 35, where the core adhesive composition is applied at a thickness ranging from 50 μm to 200 μm and cured by UV rays.

Item 37 is the method of preparing a double-sided tape of Item 34 to Item 36, where the operation of laminating the film carrier layer of the second part on the core adhesive layer includes an operation of bringing the film carrier layer of the second part into contact with the core adhesive layer and laminating them at a pressure ranging from 10 kgf to 50 kgf.

So far, the double-sided tape(s) of the present invention, an electronic device(s) containing the same, and a method of preparing the double-sided tape(s) have been described with reference to detailed embodiments. However, it should be understood that the embodiments are merely exemplary, and that the scope of the present invention is not limited thereto and has the broadest range that is covered by the basic spirit of the present specification. A person skilled in the art may be able to implement new patterns not disclosed in the present specification by combining or substituting the disclosed embodiments without departing from the scope of the present invention. In addition, a person skilled in the art may be able to easily modify or alter the disclosed embodiments based on the present specification, and it is obvious that such modifications or alterations also belong to the scope of the present invention.

### DESCRIPTION OF REFERENCE NUMERALS

100: double-sided tape 10: first film carrier layer
10′: second film carrier layer 20: first adhesive layer
20′: second adhesive layer 30: core adhesive layer
1: tempered glass 2: framing component
3: display panel

1. A double-sided tape comprising, in order, a first adhesive layer, one or more film carrier layers, and a second adhesive layer, and a core adhesive layer between the first adhesive layer and the second adhesive layer.

2. The double-sided tape of claim 1, wherein each of the first adhesive layer and the second adhesive layer has a thickness in a range of 30 μm to 100 μm.

3. The double-sided tape of claim 2, wherein each of the first adhesive layer and the second adhesive layer has a thickness of 50 μm.

4. The double-sided tape of claim 1, wherein each of the first adhesive layer and the second adhesive layer is an adhesive layer consisting of an acryl-based polymer.

5. The double-sided tape of claim 4, wherein either one or both of the first adhesive layer and the second adhesive layer consisting of an adhesive composition containing:
a) an alkyl (meth)acrylate at 85 to 99 parts by weight;
b) a vinyl carboxylic acid at 1 to 15 parts by weight;
c) a triazine-containing crosslinker at 0.05 to 0.4 parts by weight with respect to 100 parts by weight of the alkyl (meth)acrylate plus the vinyl carboxylic acid; and
d) a terpene phenolic copolymer at 5 to 50 parts by weight with respect to 100 parts by weight of the alkyl (meth)acrylate plus the vinyl carboxylic acid.

6. The double-sided tape of claim 5, wherein the alkyl (meth)acrylate is contained at 90 parts by weight, the vinyl carboxylic acid is contained at 10 parts by weight, c) is contained at 0.2 parts by weight with respect to 100 parts by weight of the alkyl (meth)acrylate plus the vinyl carboxylic acid, and the terpene phenolic copolymer is contained at 25 parts by weight with respect to 100 parts by weight of the alkyl (meth)acrylate plus the vinyl carboxylic acid.

7. The double-sided tape of claim 5, wherein the alkyl (meth)acrylate includes at least one of isooctyl acrylate, 2-ethylhexyl acrylate and butyl acrylate, and the vinyl carboxylic acid includes at least one of acrylic acid, methacrylic acid, itaconic acid and maleic acid.

8. The double-sided tape of claim 5, wherein the first adhesive layer and the second adhesive layer consist of different adhesive compositions from each other.

9. The double-sided tape of claim 1, wherein the film carrier layers are provided in a pair, and the core adhesive layer is interposed between the pair of film carrier layers.

10. The double-sided tape of claim 9, wherein the first adhesive layer, either one of the pair of film carrier layers, the core adhesive layer, the other one of the pair of film carrier layers and the second adhesive layer are laminated in a written order.

11. The double-sided tape of claim 1, wherein the film carrier layer has a thickness in the range of 1.7 μm to 100 μm.

12. The double-sided tape of claim 11, wherein the film carrier layer has a thickness of 38 μm.

13. The double-sided tape of claim 1, wherein the film carrier layer is a polyethylene terephthalate (PET) carrier layer.

14. The double-sided tape of claim 13, wherein either one or both sides of the film carrier layer has a primer layer formed thereon.

15. The double-sided tape of claim 1, wherein the core adhesive layer has a thickness in a range of 50 μm to 200 μm.

16. The double-sided tape of claim 15, wherein the core adhesive layer has a thickness of 130 μm.

17. The double-sided tape of claim 1, wherein the core adhesive layer is an adhesive layer that consists of an acryl-based polymer.

18. The double-sided tape of claim 17, wherein the core adhesive layer consists of an adhesive composition containing:
a) an alkyl (meth)acrylate at 94 to 100 parts by weight;
b) a vinyl carboxylic acid at 0 to 6 parts by weight;
c) a triazine-containing crosslinker at 0.05 to 0.4 parts by weight with respect to 100 parts by weight of the alkyl (meth)acrylate plus the vinyl carboxylic acid; and
d) a terpene phenolic copolymer at 0 to 30 parts by weight with respect to 100 parts by weight of the alkyl (meth)acrylate plus the vinyl carboxylic acid.

19. The double-sided tape of claim 18, wherein the alkyl (meth)acrylate is contained at 97 parts by weight, the vinyl carboxylic acid is contained at 3 parts by weight, c) is contained at 0.2 parts by weight with respect to 100 parts by weight of the alkyl (meth)acrylate plus the vinyl carboxylic acid, and the terpene phenolic copolymer is contained at 15 parts by weight with respect to 100 parts by weight of the alkyl (meth)acrylate plus the vinyl carboxylic acid.

20. The double-sided tape of claim 18, wherein the alkyl (meth)acrylate includes at least one of isooctyl acrylate, 2-ethylhexyl acrylate and butyl acrylate, the vinyl carboxylic acid includes at least one of acrylic acid, methacrylic acid, itaconic acid and maleic acid.

21. The double-sided tape of claim 1, wherein the core adhesive layer has a lower glass transition temperature in comparison to the first adhesive layer and the second adhesive layer.

22. The double-sided tape of claim 21, wherein the core adhesive layer has a glass transition temperature in a range of −40° C. to −20° C.

23. The double-sided tape of claim 1, wherein the double-sided tape has a thickness in a range of 300 μm to 310 μm, and sum of thicknesses of the film carrier layer and first or second adhesive layer is in a range of 80 μm to 90 μm.

24. The double-sided tape of claim 23, wherein the film carrier layer, the first adhesive layer, the second adhesive layer and the core adhesive layers have thicknesses of 38 μm, 50 μm, 50 μm and 130 μm, respectively.

25-37. (canceled)
